(19) United States
(12) Patent Application Publication
(10) Pub. No.: US 2009/0295331 A1
(43) Pub. Date: Dec. 3, 2009

(54) CHARGING DEVICE

(75) Inventor: Peng-Feng KAO, Taipei County (TW)

Correspondence Address: Muncy, Geissler, Olds & Lowe, PLLC, P.O. BOX 1364, FAIRFAX, VA, 22038-1364, US

(73) Assignee: PRINCETON TECHNOLOGY CORPORATION

(21) Appl. No.: 12/175,953

(22) Filed: Jul. 18, 2008

(30) Foreign Application Priority Data
May 27, 2008 (TW) 097119490

(51) Int. Cl. H02J 7/00

(52) U.S. Cl. 320/132

(57) ABSTRACT

The invention provides a charging device for charging a battery. The charging device includes a measuring unit, a comparing unit and a control unit. The measuring unit is used for measuring the battery and generating a measuring value. The comparing unit is coupled to the measuring unit for comparing the measuring value with a first threshold, a second threshold and a third threshold and generating a comparing result. The control unit is coupled to the comparing unit for executing a predetermined manner according to the comparing result, wherein the predetermined manner is charging or discharging the battery.

### CROSS REFERENCE TO RELATED APPLICATIONS

This Application claims priority of Taiwan Patent Application No. 97119490, filed on May 27, 2008, the entirety of which is incorporated by reference herein.

### BACKGROUND OF THE INVENTION

1. Field of the Invention

The present invention relates to a charging unit, and in particular relates to a charging unit which increases the lifespan of a battery.

2. Description of the Related Art

As technology improves popularity of portable electronic products easy to carry increase. Each electronic product comprises a battery assembled therein, providing a power source for the electronic product. Thus, electrical storage capabilities and lifespan of batteries directly affect the performance of portable electronic products.

Generally, the battery is charged via a charger. The charger transforms the mains electricity and then conveys to the inner of the battery for charging. Charging is stopped when the battery is saturated, thus, charging is accomplished. However, after the battery is repeatedly charged, the lifespan of the battery is progressively decreased. Further, excessive charging and discharging causes damage to the battery. Thus, it is an important issue to prevent batteries from excessive charging and discharging, to improve the efficiency and the lifespan of the battery for battery manufacturers.

### BRIEF SUMMARY OF THE INVENTION

The invention provides a charging device including a measuring unit, a comparing unit and a control unit. The measuring unit is used for measuring the battery and generating a measuring value. The comparing unit is coupled to the measuring unit for comparing the measuring value with a first threshold, a second threshold and a third threshold and generating a comparing result. The control unit is coupled to the comparing unit for executing a predetermined manner according to the comparing result, wherein the predetermined manner is charging or discharging the battery.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIG. 1 is a schematic view of a charging device of the invention; and

FIG. 2 is a schematic view of a first threshold, a second threshold and a third threshold of a charging device of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

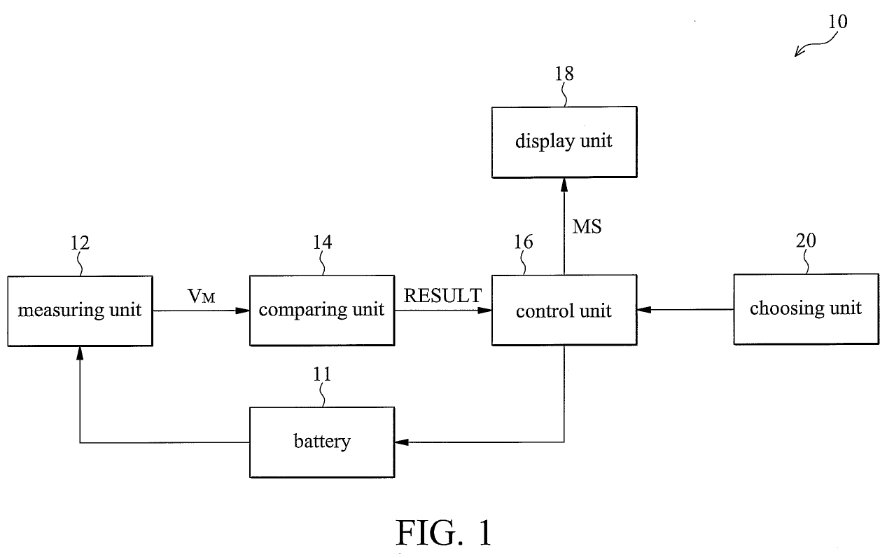

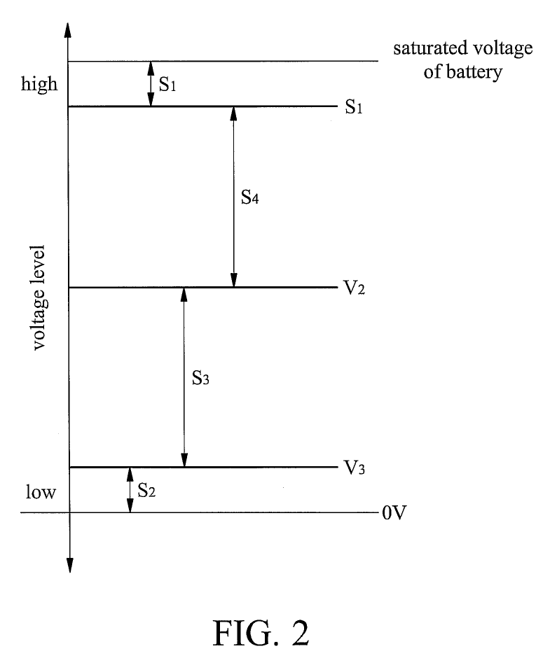

Referring to FIGS. 1 and 2, FIG. 1 is a schematic view of a charging device of the invention, and FIG. 2 is a schematic view of a first threshold, a second threshold and a third threshold of a charging device of the invention. Referring to FIGS. 1 and 2, a charging device 10 of the invention includes a measuring unit 12, a comparing unit 14 and a control unit 16. The measuring unit 12 is used for measuring the battery 11 and generating a measuring value V_{M}. The comparing unit 14 is coupled to the measuring unit 12 for comparing the measuring value with a first threshold V₁, a second threshold V₂ and a third threshold V₃ and generating a comparing result RESULT. The control unit 16 is coupled to the comparing unit 14 for executing a predetermined manner according to the comparing result RESULT, wherein the predetermined manner is charging or discharging the battery 11.

The first threshold V₁ is a high voltage level. The third threshold V₃ is a low voltage level. The second threshold V₂ has a voltage level between the high voltage level and the low voltage level. In this embodiment, the first threshold V₁, the second threshold V₂ and the third threshold V₃ are adjusted and set according to user requirement.

Embodiments of the charging device 10 of the invention are described as follows: when the comparing result RESULT shows that the measuring value V_{M} is greater than the first threshold V₁ (the region at an arrow S₁), the control unit 16 does not execute any action. When the comparing result RESULT shows that the measuring value V_{M} is less than the third threshold V₃ (the region at an arrow S₂), the control unit 16 executes a first predetermined action to charge the battery 11. In this embodiment, the first predetermined action is charging the battery 11 until the voltage level of the battery 11 achieves the first threshold V₁.

When the comparing result RESULT shows that the measuring value V_{M} is between the second threshold V₂ and the third threshold V₃ (the region at an arrow S₃), the control unit 16 executes a second predetermined action to discharge the battery 11 and then to charge the battery 11. In this embodiment, the second predetermined action is discharging the battery 11 until the voltage level of the battery 11 achieves the third threshold V₃ and then charging the battery 11 until the voltage level of the battery 11 achieves the first threshold V₁.

When the comparing result RESULT shows that the measuring value V_{M} is between the first threshold V₁ and the second threshold V₂ (the region at an arrow S₄), the control unit 16 executes a third predetermined action. The third predetermined action generates a selection signal MS. The charging device 10 further includes a display unit 18 and a selection unit 20. The display unit 18 and the selection unit 20 are respectively coupled to the control unit 16. The display unit displays the selection signal MS. The selection unit 20 is used by a user for selecting whether the control unit 16 executes the first predetermined action or does not execute any action. Via the selection signal MS displayed by the display unit 18, a user knows the voltage level of the battery 11 between the first threshold V₁ and the second threshold V₂. Usually, when the voltage level of the battery 11 is between the first threshold V₁ and the second threshold V₂, charging the battery 11 decreases the lifespan of the battery 11. Thus, in this embodiment, when the voltage level of the battery 11 is between the first threshold V₁ and the second threshold V₂, the display unit 18 displays the selection signal MS for a user. Therefore, a user can decide whether the battery 11 is charged or not via the selection unit 20. In this embodiment, the selection unit 20 includes a key or other interfaces that can provide a selection function.

The charging device 10 of the invention sets a charging voltage level (the first threshold V₁), the second threshold V₂ and a discharging voltage level (the third threshold V₃). When the electric power stored in the battery 11 exceeds the charging voltage level, the charger stops charging the battery 11. Similarly, when the electric power stored in the battery 11 is less than the discharging voltage level, the charger stops discharging the battery 11. Therefore, the problems of the excess charging and excessive discharging are prevented. The second threshold V₂ is used to determine whether the battery 11 is discharged and then charged. Via the above tiresholds, charging for the battery 11 becomes more efficient and the lifespan of the battery 11 is increased.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A charging device, comprising
a measuring unit measuring a battery and generating a measuring value;
a comparing unit coupled to the measuring unit for comparing the measuring value with a first threshold, a second threshold and a third threshold and generating a comparing result; and
a control unit coupled to the comparing unit for executing a predetermined manner according to the comparing result,
wherein the predetermined manner is charging or discharging the battery.

2. The charging device as claimed in claim 1, wherein the first threshold is a high voltage level, the third threshold is a low voltage level, and the second threshold has a voltage level between the high voltage level and the low voltage level.

3. The charging device as claimed in claim 1, wherein when the comparing result shows that the measuring value is greater than the first threshold, the control unit does not execute any action.

4. The charging device as claimed in claim 1, wherein when the comparing result shows that the measuring value is less than the third threshold, the control unit executes a first predetermined action to charge the battery.

5. The charging device as claimed in claim 1, wherein the first predetermined action is charging the battery until the voltage level of the battery achieves the first threshold.

6. The charging device as claimed in claim 1, wherein when the comparing result shows that the measuring value is between the second threshold and the third threshold, the control unit executes a second predetermined action to discharge the battery and then to charge the battery.

7. The charging device as claimed in claim 6, wherein the second predetermined action is discharging the battery until the voltage level of the battery achieves the third threshold and then charging the battery.

8. The charging device as claimed in claim 7, wherein the second predetermined action is discharging the battery until the voltage level of the battery achieves the third threshold and then charging the battery until the voltage level of the battery achieving the first threshold.

9. The charging device as claimed in claim 4, wherein when the comparing result shows that the measuring value is between the first threshold and the second threshold, the control unit executes a third predetermined action to generate a selection signal.

10. The charging device as claimed in claim 9, further comprising a display unit coupled to the control unit for displaying the selection signal.

11. The charging device as claimed in claim 10, further comprising a selection unit coupled to the control unit for selecting whether the control unit executes the first predetermined action or not.

12. The charging device as claimed in claim 11, wherein the selection unit comprises at least a key.

13. The charging device as claimed in claim 1, wherein the measuring unit measures a voltage level of the battery.
